(19) United States
(12) Patent Application Publication
(10) Pub. No.: US 2014/0340337 A1
(43) Pub. Date: Nov. 20, 2014

(54) DISPLAY APPARATUS AND CONTROL METHOD THEREOF

(71) Applicant: Samsung Electronics Co., Ltd., Suwon-si (KR)

(72) Inventor: Jae-ryong HAN, Cheonan-si (KR)

(73) Assignee: Samsung Electronics Co., Ltd., Suwon-si (KR)

(21) Appl. No.: 14/279,586

(22) Filed: May 16, 2014

(30) Foreign Application Priority Data
May 16, 2013 (KR) 10-2013-0055798

(51) Int. Cl. G06F 3/0488

(52) U.S. Cl. CPC G06F 3/04883
USPC 345/173

(57) ABSTRACT

A display apparatus includes a display configured to display a plurality of objects, a sensor configured to detect a touch input on the display, and a controller configured to set a control region based on a plurality of touch inputs detected at different locations of the display and perform a function with respect to at least one object included in the control region according to an additional operation of at least one touch input among the plurality of touch inputs.

### CROSS-REFERENCE TO RELATED APPLICATION

This application claims priority from Korean Patent Application No. 10-2013-0055798, filed on May 16, 2013, in the Korean Intellectual Property Office, the disclosure of which is incorporated herein by reference in its entirety.

### BACKGROUND

1. Field

Apparatuses and methods consistent with exemplary embodiments relate to a display apparatus and a control method thereof, and more particularly, to a display apparatus for grouping and spreading various objects displayed on a screen easily and rapidly and a control method thereof.

2. Description of the Related Art

Recently, with development of a display technology using displays such as liquid crystal displays (LCDs), ultrahigh definition televisions (UHDs), or organic light emitting diodes (OLEDs), it is possible to implement a large-scale screen which meets requirements of picture quality, resolution, color sense, power consumption, and the like. An example of the large-scale screen used in real life includes an electronic blackboard, an electronic table (see FIG. 1A), and the like. A touch panel is mounted on the large-scale screen to recognize a touch input, and a graphic user interface (GHI) is provided to allow a user to intuitively view and use the large-scale screen.

However, in the related art, as illustrated in FIG. 1A, when there are a plurality of objects on a screen configured to support a touch interface, to move the objects to a desired location, the user needs to repeatedly perform an operation of moving each of the objects to the desired location by touching and dragging each of the objects, as shown in FIG. 1B.

Further, it is not easy to touch or drag objects which are in a range beyond reach, e.g., a distance L in FIG. 1B, or touch or drag the objects to desired locations which are in a range beyond reach.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a display apparatus which controls objects on a screen through a control region set based on a plurality of touch inputs and a control method thereof.

According to an aspect of an exemplary embodiment, there is provided a display apparatus. The display apparatus may include: a display configured to display a plurality of objects; a sensor configured to detect a touch input on the display; and a controller configured to set a control region based on a plurality of touch inputs detected at different locations of the display and perform a function with respect to at least one object included in the control region according to an additional touch operation of at least one touch input among the plurality of touch inputs.

The controller may set the control region extended from a region formed by a plurality of touch input points in which the plurality of touch inputs are detected.

The controller may perform at least one of an object grouping function and an object spreading function according to the additional touch operation of the at least one touch input.

The plurality of touch inputs may include a first touch input through a third touch input, and the controller may set the control region extended from a fan-shaped region, having a vertex which is a first touch input point in which the first touch input is detected and radii are lines formed by the first touch input point and second and third touch input points in which a second and the third touch inputs are detected.

The first touch input may be input in a state in which the second and the third touch inputs are maintained for a preset period of time after the second and the third touch inputs are detected.

The additional touch operation may be a dragging operation and the controller may control to spread the at least one object included in the control region when a dragging operation of the first touch input is input in a direction such that radii of the fan-shaped region formed by the first touch input point and the second and the third touch input points are reduced, and controls to group the at least one object included in the control region when the dragging operation of the first touch input is input in a direction such that the radii of the fan-shaped region are increased.

The controller may adjust a size of the control region according to an additional touch operation of at least one of the second and the third touch input.

The controller may perform an editing function for the at least one object included in the control region when the plurality of touch inputs are maintained for a preset period of time.

According to an aspect of another exemplary embodiment, there is provided a method of controlling a display apparatus. The method may include: detecting touch inputs on a screen; setting a control region based on a plurality of touch inputs detected at different points of the screen; and performing a function for at least one object included in the control region according to an additional touch operation of at least one touch input among the plurality of touch inputs.

The setting may include setting the control region extended from a region formed by a plurality of touch input points in which the plurality of touch inputs are detected.

The performing may include performing at least one of an object grouping function and an object spreading operation according to the additional touch operation of the at least one touch input.

The plurality of touch inputs may include a first touch input through a third touch input, and the setting may include setting the control region extended from a fan-shaped region, having a vertex which is a first touch input point in which the first touch input is detected, and radii are lines formed by second and third touch input points in which a second and the third touch inputs are detected are radii.

The first touch input may be input in a state in which the second and the third touch inputs are maintained for a preset period of time after the second and the third touch inputs are sensed.

The additional touch operation may be a dragging operation, and the performing may include spreading the at least one object included in the control region when a dragging operation of the first touch input is input in a direction such that radii of the fan-shaped region formed by the first touch input point and the second and the third touch input points are reduced, and grouping the at least one object included in the control region when the dragging operation of the first touch input is input in a direction such that the radii of the fan-shaped region are increased.

The method may further include adjusting a size of the control region according to an additional touch operation of at least one of the second and the second touch inputs.

The method may further include performing an editing function for the at least one object included in the control region when the plurality of touch inputs are maintained for a preset period of time.

According to an aspect of still another exemplary embodiment, a display apparatus is provided. The display apparatus may include a processor configured to set a control region based on a plurality of touch inputs detected at different locations of a display and control at least one object included in the control region according to an additional touch operation in the control region.

### BRIEF DESCRIPTION OF THE DRAWINGS

The above and/or other aspects will be more apparent by describing in detail exemplary embodiments, with reference to the accompanying drawings, in which:

FIG. 1A illustrates a related art electronic table;

FIG. 1B is a view for explaining grouping and spreading operations in the related art;

FIG. 2 is a block diagram illustrating a configuration of a display apparatus according to an exemplary embodiment;

FIGS. 3 to 5 are views illustrating a process of setting a control region according to exemplary embodiments;

FIGS. 6 to 9 are views illustrating a process of performing an object grouping function or an object spreading function according to exemplary embodiments;

FIGS. 10 and 11 are views illustrating a process of grouping or spreading a selected object by adjusting a size of a control region according to exemplary embodiments;

FIG. 12 is a view illustrating a process of performing of an editing function using a control region according to an exemplary embodiment;

FIG. 13 is a view illustrating an application example in a smart phone according to an exemplary embodiment; and

FIG. 14 is a flowchart illustrating a process of object grouping and object spreading by a detected touch input according to an exemplary embodiment.

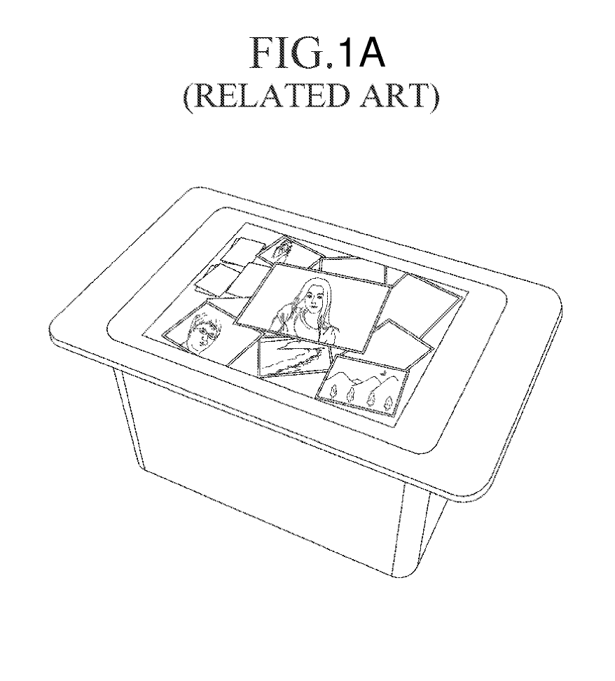

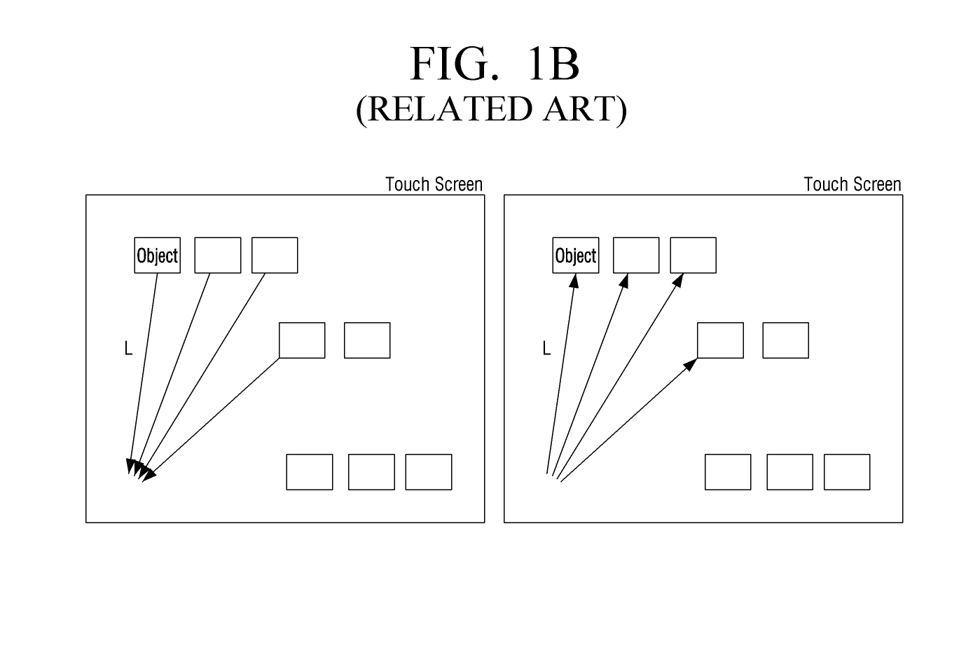

### DETAILED DESCRIPTION

Hereinafter, exemplary embodiments will be described in more detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

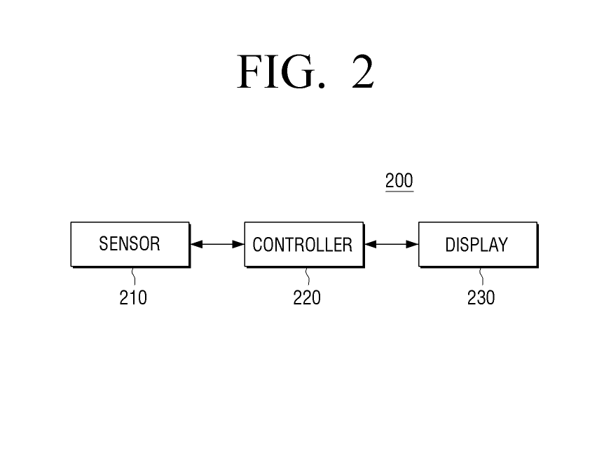

FIG. 2 is a block diagram illustrating a configuration of a display apparatus according to an exemplary embodiment.

Referring to FIG. 2, a display apparatus 200 includes a sensor 210, a display 230, and a controller 220. The display apparatus 200 may be implemented as various types of electronic apparatuses, such as a television (TV), an electronic blackboard, an electronic table, a large format display (LFD), a smart phone, a tablet, a desk top personal computer (PC), or a laptop PC. Here, the electronic blackboard may include, for example, a liquid crystal display (LCD) type blackboard, a plasma display panel (PDP) type electronic blackboard, a rear projection type electronic blackboard, a front projection type electronic blackboard, an electronic blackboard for conference, or an electronic lectern.

The display 230 displays a plurality of objects.

The plurality of objects may include an icon such as an image icon, a moving image icon, or a text icon or an application as well as an image displayed on a screen, a moving image, a text, an Internet window currently executed, a music file, or the like.

For example, when the display apparatus 200 is an electronic blackboard, the object may be an image, a moving image, or a text, and when the display apparatus 200 is a smart phone, the object may be an application.

The sensor 210 may detect a touch input with respect to the display 230. The sensor 210 may be configured as, for example, a touch panel or a touch screen. The touch panel is a transparent switch panel coupled to a cathode ray tube (CRT), an LCD, or the like of the display apparatus 200 and configured to control the display apparatus 200 when pressed, for example, in a place in which a text, a picture, or the like is displayed. The transparent switch may include an optical type using infrared, a transparent electrode type using a contact of a transparent conductive layer in which an indium tin oxide (ITO) layer is coated on a polyester film, a transparent conductive film type in which a stainless steel wire is buried in a transparent conductive film, a capacitive type which detects a change in capacitance, a type which detects a touch location by distributing power of a pressure sensor disposed around the panel with respect to pressure of a fingertip touched on the panel, or the like.

The touch screen is referred to as a screen which may receive input data through the screen. When a finger of a human being or an object is touched on a character displayed on the touch screen or a specific location of the touch screen without using a keyboard, a touch location may be recognized and specific processing may be performed according to the detected touch. Further, the touch screen may be provided by coupling an apparatus such as a touch panel to a screen of a monitor of the display apparatus 200, and when a character or an image displayed on the screen mounted with the touch panel is touch by a hand of a user, the touch screen may recognize the character or the image selected by the user according to the contacted location of the screen, and allow a computer system of the display apparatus 200 to process a command corresponding to the selected character or image.

The sensor 210 may detect a plurality of touch inputs input through the touch panel or the touch screen.

The plurality of touch input may include, for example, a plurality of touch inputs input at different locations of the display 230 with a time difference therebetween, a plurality of touch inputs simultaneously input at different locations of the display 230, or a plurality of touch inputs input at the same location of the display 230 at different times.

The controller 220 controls an overall operation of the display apparatus 200. The controller 220 may include a microcomputer (or a microcomputer and a central processing unit (CPU)), and a random access memory (RAM) and a read only memory (ROM) for an operation of the display apparatus 200. The controller 220 may be implemented in a system on chip (SoC).

The controller 220 may set a control region based on a plurality of touch inputs detected at different points of the display 230.

Here, the sensor 210 may recognize the plurality of touch inputs with respect to the display 230, and transmit information corresponding to the plurality of touch inputs to the controller 220. The controller 220 may determine whether the plurality of touch inputs are detected at different points of the display 230 or detected at the same point based on the information corresponding to the plurality of touch inputs transmitted from the sensor 210.

When it is determined that the plurality of touch inputs are detected at the different points of the display 230, the controller 220 may set the control region based on the plurality of detected touch inputs. The control region is a region set based on the plurality of touch inputs detected at the different points, and may be a region to perform various functions, such as, for example, copy, drag and drop, delete, execute, group and spread, magnify, or reduce, with respect to objects displayed on the screen.

When it is determined that the plurality of touch inputs are detected at the same point of the display 230, the controller 220 may perform a function to, for example, magnify or reduce a screen of a plurality of touch input points.

The controller 220 may set the control region extended from a region formed by the plurality of touch input points in which the plurality of touch inputs are detected. Therefore, the controller 220 may control at least one object included in the extended region among objects located farther away using the control region extended from the region formed by the plurality of touch input points.

The controller 220 may perform a function with respect to at least one object included in the control region among the plurality of objects displayed on the screen according to a dragging operation of at least one touch input among the plurality of touch inputs.

Specifically, the sensor 210 may recognize the dragging operation of the at least one touch input among the plurality of touch inputs and transmit dragging input information to the controller 220. When the controller 220 receives the dragging input information of the at least one touch input among the plurality of touch inputs from the sensor 210, the controller 220 may perform a function corresponding to the dragging input.

For example, when the controller 220 receives the dragging operation information of the at least one touch input among the plurality of touch inputs with respect to the display 230, the controller 220 may perform a function, such as edit, group, spread, or transfer, with respect to at least one object included in the control region set based on the plurality of touch inputs.

For example, the controller 220 may perform an object grouping function or an object spreading function according to a direction of the dragging operation of the at least one touch input among the plurality of touch inputs.

For example, the controller 220 may perform the object grouping function when a dragging direction of the at least one touch input among the plurality of touch inputs is a direction moving away from a location in which objects are located, and the controller 220 may perform the object spreading function when the dragging direction is a direction moving toward a location in which the objects are grouped.

Hereinafter, setting of the control region and performing the object grouping or spreading function according to exemplary embodiments will be described in detail with reference to the accompanying drawings.

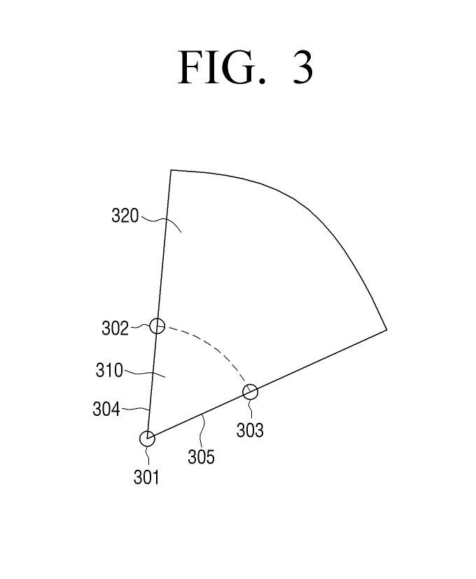

FIGS. 3 to 5 are views illustrating a process of setting a control region according to exemplary embodiments.

Referring to FIG. 3, the plurality of touch inputs may include a first through a third touch inputs 301, 302, and 303. The first touch input 301 may be input in a state in which the second and third touch inputs 302 and 303 are maintained for a preset period of time after the second and third touch inputs 302 and 303 are initially detected.

Specifically, after the second touch input 302 and the third touch input 303 are input simultaneously or sequentially and detected in the sensor, when another touch input is detected in a state in which the second and third touch inputs 302 and 303 are maintained for the preset period of time, the controller 220 may determine the other touch input as the first touch input 301.

The controller 220 may set a control region 320 extended from a fan-shaped region 310, a vertex of which is a first touch input point in which the first touch input 301 is detected and radii are lines 304 and 305 formed by the first input point and second and third touch input points in which the second and third touch inputs 302, 303 are detected. The control region 320 may have a radius which is proportional to the radius 304 or 305. As described above, the control region 320 may be a region set based on a plurality of touch inputs detected at different points, and a region in which various functions, for example, copy, drag and drop, delete, execute, group and spread, magnify, reduce, and the like with respect to an object displayed on the screen are performed.

Specifically, the controller 220 may set the control region 320 extended according to an increase in lengths of radii 304, 305 and thus an increase in a length of an arc of the fan-shaped region 310 formed by the first, second and third touch input points.

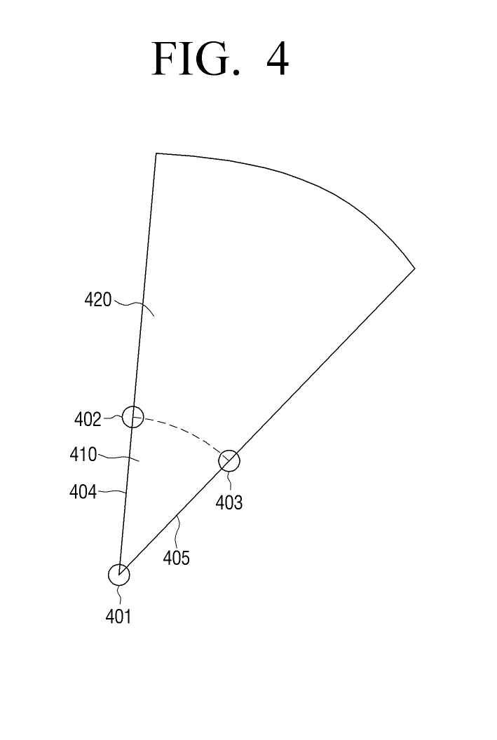

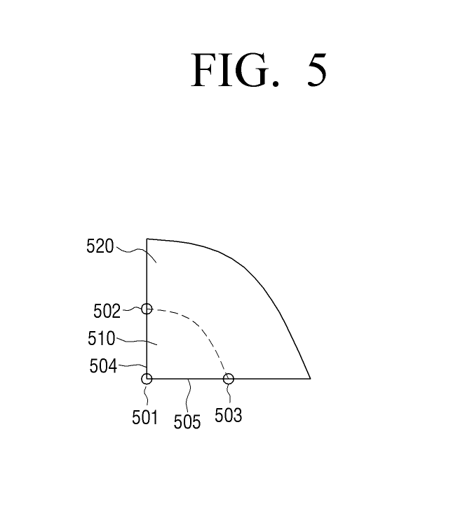

A rate of extension of the control region 320 is proportional to the lengths of the radii of the fan-shaped region 310 formed by the first through the third touch input points. That is, as illustrated in FIG. 4, when lines 404 and 405 formed by a first touch input point in which a first touch input 401 is detected and second and third touch input points in which second and third touch inputs 402 and 403 are detected are increased compared to the lines 305 and 310 of FIG. 3, length of radii of a fan-shaped region 410 are increased, and thus the controller 220 may set a region 420, in which the fan-shaped region 410 formed by the first through third touch input points is extended in proportion to the increased lengths of the radii, as the control region. On the other hand, as illustrated in FIG. 5, when lines 504 and 505 formed by a first touch input point in which a first touch input 501 is detected and second and third touch input points in which second and third touch inputs 502 and 503 are detected are reduced compared to the lines 305 and 310 of FIG. 3, lengths of radii of a fan-shaped region 510 are reduced, and thus the controller 220 may set a region 520, in which the fan-shaped region 510 formed by the first through third touch input points is extended in proportion to the reduced lengths of the radii, as the control region.

In an exemplary embodiment, the controller 220 may adjust the extension rate of the fan-shaped region formed by the first through third touch input points in proportional to the lengths of the lines formed by the first through third touch input points, and set the region extended according to the adjusted extension rate as the control region.

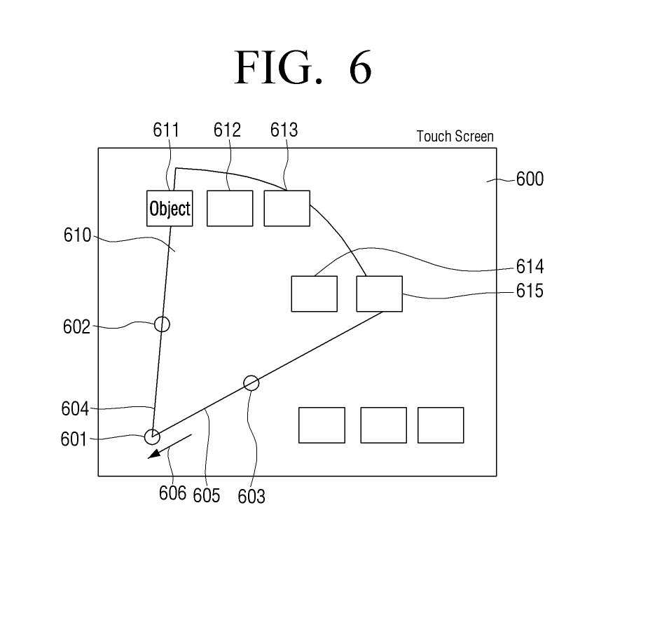

FIGS. 6 to 9 are views illustrating a process of performing an object grouping or spreading function according to exemplary embodiments.

Referring to FIG. 6, when a dragging operation of a first touch input is input in a direction 606 such that radii 604 and 605 of a fan-shaped region formed by a first touch input point and the second and third touch input points are increased, the controller 220 may control a plurality of objects 611, 612, 613, 614, and 615 included in or overlapped with a control region 610 to be grouped and displayed on a display 600.

As described above, after a second touch input 602 and a third touch input 603 are input simultaneously or sequentially and detected by the sensor, when another touch input is detected in a state in which the second and third touch inputs 602 and 603 are maintained for a preset period of time, the controller 220 may determine the other touch input as the first touch input 601.

After the first touch input 601 is detected, when the sensor detects that a location of the first touch input point is continuously changed, the controller may determine that a dragging operation of the first touch input 601 is input.

Further, the controller may determine a dragging direction of the first touch input 601 when it is determined that the dragging operation of the first touch input 601 is input.

Specifically, the controller may determine that the radii 604 and 605 of the fan-shaped region formed by the first touch input point and the second and third touch input points are increased when the first touch input point is continuously moved away from the second and third touch input points, and therefore determine that the first touch input point moves to the direction 606 in which the radii 604 and 605 are increased.

The controller may perform a function to group the plurality of objects 611, 612, 613, 614, and 615 included in or overlapped with the control region 610 when the first touch input point moves to the direction 606 such that the radii of the fan-shaped region formed by the first touch input point and the second and third touch input points are increased.

Here, the objects 611, 612, 613, 614, and 615 included in or overlapped with the control region 610 may include objects 612 and 614 entirely included in the control region 610, objects 611, 613, and 615 partially included in the control region 610, and objects (not shown) in contact with the control region 610.

The controller may not perform the function to group the plurality of objects 611, 612, 613, 614, and 615 included in the control region 610 when the first touch input point is continuously moved away from the second touch input point and is continuously moved toward to the third touch input point, and vice versa.

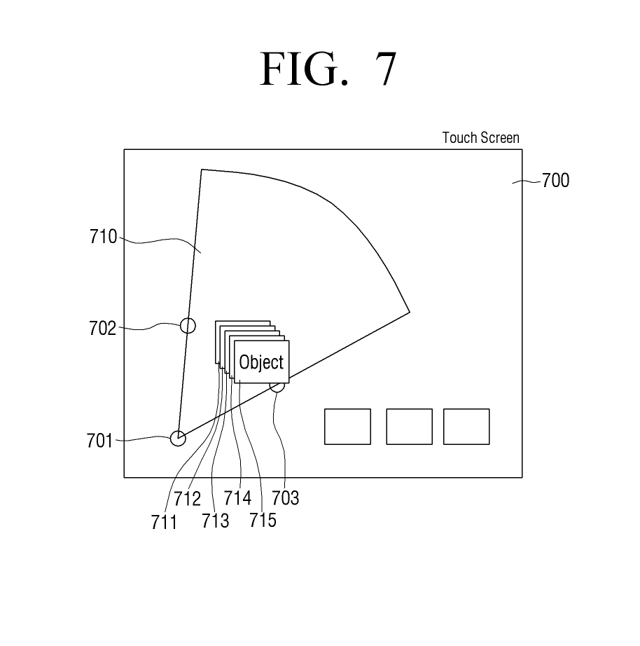

FIG. 7 is a view illustrating a state in which a plurality of objects 711, 712, 713, 714, and 715 are grouped.

The controller may move the plurality of objects 711, 712, 713, 714, and 715 included in a control region 710 toward the first touch input point to be grouped. Here, the controller may perform grouping on the objects 711, 712, 713, 714, and 715 in a manner such that the plurality of objects 711, 712, 713, 714, and 715 are gathered to overlap one another. Alternatively, a grouping folder (not shown) may be generated and the plurality of objects 711, 712, 713, 714, and 715 may be included in the grouping folder.

For example, when the plurality of objects 711, 712, 713, 714, and 715 include a document currently being edited and a moving image currently being reproduced, the controller may display the grouping in a manner such that the currently edited document and the currently reproduced moving image are gathered to overlap each other or the currently edited document and the currently reproduced moving image are included in a grouping folder (not shown).

Here, the controller may maintain a state in which the currently edited document and the currently reproduced moving image are executed during and after the processing of grouping the currently edited document and the currently reproduced moving image.

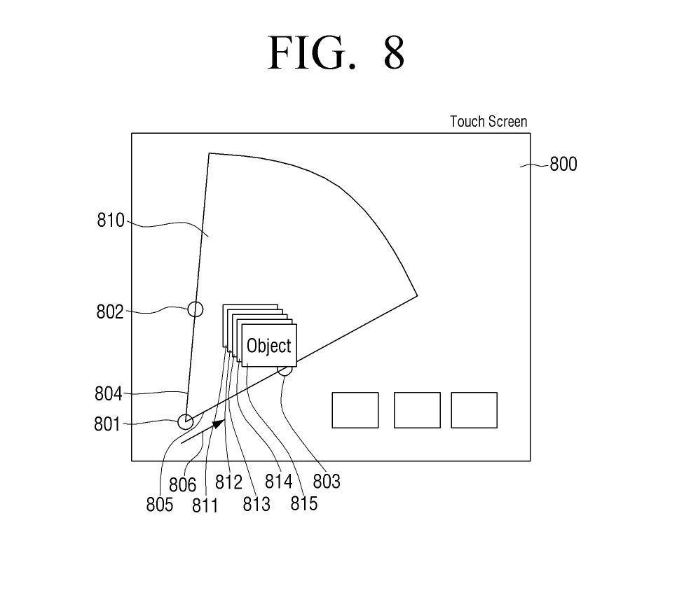

Referring to FIG. 8, in a state in which a plurality of objects 811, 812, 813, 814, and 815 are grouped, when a dragging operation of a first touch input 801 is input in a direction 806 such that radii 804 and 805 of a fan-shaped region formed by a first touch input point and second and third touch input points are reduced, the controller may control the plurality of objects 811, 812, 813, 814, and 815, which are included in a control region 810 and grouped, to be spread out and displayed in a display 800.

Similar to the previous exemplary embodiments, after the second touch input 802 and the third touch input 803 are input simultaneously or sequentially and detected by the sensor, when another touch input is detected in a state in which the second and third touch inputs 802 and 803 are maintained for a preset period of time, the controller 220 may determine the other touch input as the first touch input 801.

After the first touch input 801 is detected, when the sensor detects that a location of the first touch input point is continuously changed, the controller may determine that a dragging operation of the first touch input 801 is input.

Further, the controller may determine a dragging direction when it is determined that the dragging operation of the first touch input 801 is input.

Specifically, the controller may determine that the radii 804 and 805 of the fan-shaped region formed by the first touch input point and the second and third touch input points are reduced when it is determined that the first touch input point is continuously moved closer to the second and third touch input points. In this case, the controller may determine that the first touch input point moves to the direction 806 in which the radii 804 and 805 are reduced.

The controller may perform a function to spread the plurality of objects 811, 812, 813, 814, and 815 included in the control region 810 and grouped when it is determined that the first touch input point moves to the direction 806 in which the radii 804 and 805 are reduced.

Here, the objects 811, 812, 813, 814, and 815 may be included in the control region 810 and grouped such that all objects grouped are included in the control region 810, portions of the objects grouped are included in the control region 810, or the objects grouped are in contact with the control region 810.

The controller may not perform the function to spread the plurality of objects 811, 812, 813, 814, and 815 included in the control region 810 when the first touch input point is continuously moved closer to the second touch input point and is continuously moved away from the third touch input point, and vice versa.

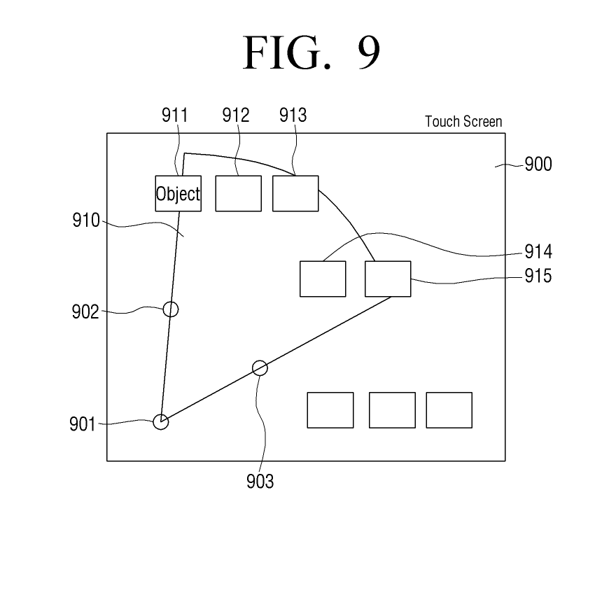

FIG. 9 is a view illustrating a state in which a plurality of objects 911, 912, 913, 914, and 915 are spread.

The controller may move the plurality of objects 911, 912, 913, 914, and 915, previously grouped and included in a control region 910, to be spread according to a dragging direction of the first touch input point. Here, the controller may control the plurality of objects 911, 912, 913, 914, and 915, previously grouped in overlap with one another, to be separated and spread. Alternatively, the controller may control a grouping folder, in which the plurality of objects 911, 912, 913, 914, and 915 are grouped and included, to be removed and the plurality of objects 911, 912, 913, 914, and 915 to be separated and spread.

Here, the controller may maintain a state in which the plurality of objects 911, 912, 913, 914, and 915 are executed during and after the processing of spreading the plurality of objects 911, 912, 913, 914, and 915 is executed.

The controller may control a grouping distance (i.e., a distance by which the plurality of objects move to be grouped) and a spreading distance (i.e., a distance by which the plurality of objects move to be spread) for the plurality of objects according to an intensity of the dragging operation of the first touch input.

Specifically, the intensity of the dragging operation of the first touch input may be proportional to a moving distance of the first touch input point by the dragging operation. That is, the controller may determine the intensity of the dragging operation in proportional to the moving distance of the first touch input point, and control the grouping distance and the spreading distance according to the determined intensity of the dragging operation.

For example, when a user seated in a left side of an electronic table groups or spreads a plurality of objects located in a right end portion of a display, to show the plurality of objects grouped or spread to a user seat in a middle of the electronic table, the controller may control the intensity of the dragging operation of the first touch input to adjust the grouping distance and the spreading distance of the plurality of objects.

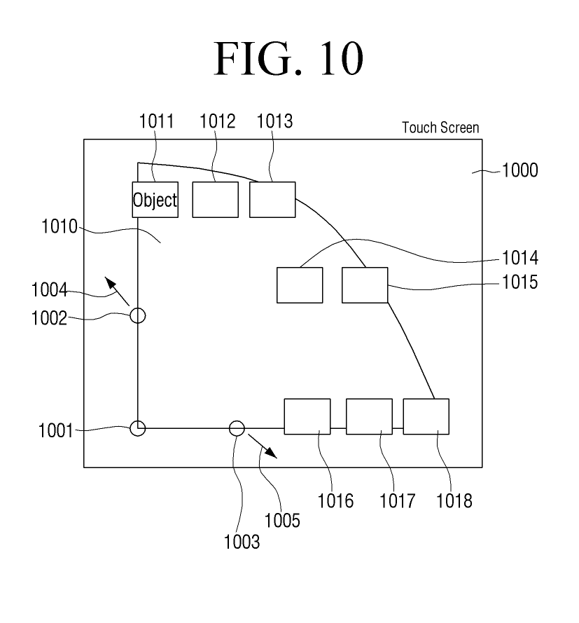

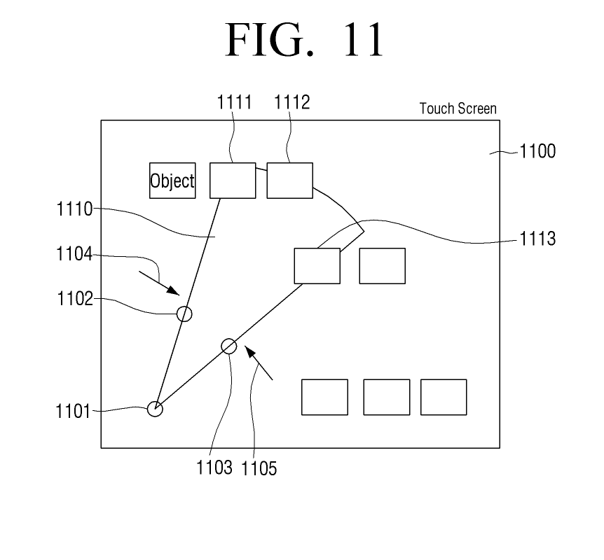

FIGS. 10 and 11 are views illustrating a grouping or spreading process with respect to a selected object by controlling a size of a control region according to exemplary embodiments.

Referring to FIGS. 10 and 11, the controller may determine a dragging operation of at least one among a second touch input 1002 and a third touch input 1003 to magnify or reduce a size of a control region 1010 according to a direction of the dragging operation.

In FIG. 10, the control region 1010 is set based on a first touch input point, a second touch input point, and a third touch input point corresponding to a first through the third touch inputs 1001, 1002, 1003, and thus, the controller may perform the grouping or spreading function with respect to objects 1011, 1012, 1013, 1014, 1015, 1016, 1017, 1018 included in or overlapped with the control region 1010. When the sensor detects that a location of the at least one of the second touch input point and the third touch input point is continuously changed, the controller may determine that the dragging operation of the at least one of the second touch input 1002 and the third touch input 1003 is input.

The controller may determine a dragging direction when it is determined that the dragging operation of the at least one among the second touch input 1002 and the third touch input 1003 is input.

Specifically, when it is determined that the at least one of the second touch input point and the third touch input point moves such that an angle formed by the second touch input point and the third touch input point relative to the first touch input point is increased, the controller may determine that the at least one of the second touch input point and the third touch input point move to directions 1004 and 1005 toward the outside of the control region 1010 set based on the first touch input point, the second touch input point, and the third touch input point.

When it is determined that the at least one of the second touch input point and the third touch input point move to the directions 1004 and 1005 toward the outside of the control region 1010 set based on the first touch input point, the second touch input point, and the third touch input point, the controller may increase an angle and a width of the control region 1010 set by the first touch input point, the second touch input point, and the third touch input point.

Therefore, the controller may perform the grouping function and the spreading function with respect to more objects using the control region 1010 of which angle and width are increased.

In FIG. 11, in a state in which a control region 1110 is set based on a first touch input point, a second touch input point, and a third touch input point, when the sensor detects that a location of at least one of the second touch input point and the third touch input point is continuously changed, the controller may determine that a dragging operation of a second touch input 1102 or a third touch input 1103 is input.

The controller may determine a dragging direction when it is determined that the dragging operation of the second touch input 1102 or the third touch input 1103 is input.

Specifically, when it is determined that the second touch input point or the third touch input point moves such that an angle formed by the second touch input point and the third touch input point relative to the first touch input point is reduced, the controller may determine that the second touch input point or the third touch input point moves to directions 1104 and 1105 toward the inside of the control region 1110 set based on the first touch input point, the second touch input point, and the third touch input point.

When it is determined that the second touch input point or the third touch input point moves to the directions 1104 and 1105 toward the inside of the control region 1110 set based on the first touch input point, the second touch input point, and the third touch input point, the controller may reduce an angle and a width of the control region 1110 set by the first touch input point, the second touch input point, and the third touch input point.

Therefore, the controller may the grouping function and the spreading function with respect to fewer objects using the control region 1110 of which angle and width are reduced.

When the controller determines that the second touch input point or the third touch input point moves to the directions 1104 and 1105 toward the inside of the control region 1110 set based on the first touch input point, the second touch input point, and the third touch input point and the angle and width of the control region 1110 are reduced, the controller may perform a function to transmit objects 1111, 1112, and 1113 in the control region 1110 when the angle and width of the control region 1110 are reduced less than a preset reference value.

The controller may set a location of the control region 1110 again when it is determined that the second touch input point and the third touch input point move the same direction.

Specifically, when the second touch input point and the third touch input point move to the same direction relative to the first touch input point, the controller may determine that the control region 1110 set based on the first touch input point, the second touch input point, and the third touch input point is rotated by moving distances of the second touch input point and the third touch input point relative to the first touch input point.

Therefore, the controller may set the control region 1110 again based on the second touch input point and the third touch input point moving to the same direction relative to the first touch input point.

For example, when objects in front of the user are grouped and spread to a left or right direction, the controller may group the objects, determine that the control region 1110 set based on the first touch input point, the second touch input point, and the third touch input point is rotated relative to the first touch input point when the second touch input point and the third point move to the same direction relative to the first touch input point in a state that the objects are grouped, and performs a spreading function in a state in which the control region 1110 is rotated to spread and display the objects to the left or right direction.

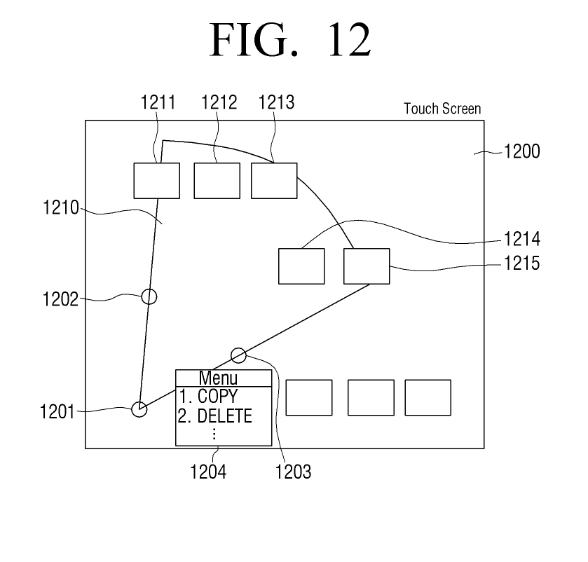

FIG. 12 is a view illustrating that an editing function is performed using a control region according to an exemplary embodiment.

When it is determined that a first touch input 1201, a second touch input 1202, and a third touch input 1203 are maintained for a preset period of time in a state in which a control region 1210 is set based on the first touch input 1201, the second touch input 1202, and the third touch input 1203, the controller may display a menu window 1204 on a display 1200.

Here, the menu window 1204 may be implemented with an on screen display (OSD) or a graphic user interface (GUI), and the controller may display the menu window 1204 which displays a sub menu including an editing function such as copy, delete, paste, and the like.

When the sub menu displayed in the menu window 1204 is selected in a state in which the menu window 1204 is displayed, the controller may perform a function corresponding to each of the sub menus for a plurality of objects 1211, 1212, 1213, 1214, and 1215 included in the control region 1210.

The controller may group or spread the plurality of objects 1211, 1212, 1213, 1214, and 1215 in a state in which the menu 1204 is displayed, and perform a function corresponding to the sub menu with respect to all or a portion of the plurality of objects grouped or spread.

Alternatively, the controller may display the menu window to perform a function corresponding to the sub menu for all or a portion of the plurality of objects 1211, 1212, 1213, 1214, and 1215 grouped or spread after the plurality of objects are grouped or spread.

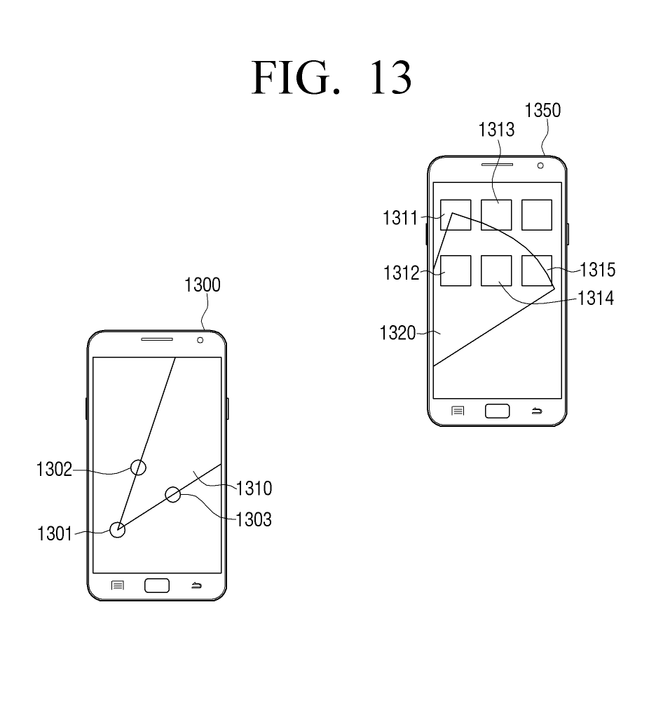

FIG. 13 is a view illustrating a case in which a grouping or spreading function is applied to a smart phone according to an exemplary embodiment.

When first through third touch inputs 1301, 1302, and 1303 are detected on a screen of a first smart phone 1300, the controller of the first smart phone 1300 may set a control region 1310 extended from a fan-shaped region a vertex of which is a first touch input point in which the first touch input 1301 is detected and radii are lines formed by the first touch input point and second and third touch input points in which the second and third touch inputs 1302 and 1303 are detected.

As described above, the first touch input 1301 may be input in a state in which the second and third touch inputs 1302 and 1303 are maintained for a preset period of time after the second and third touch inputs 1302 and 1303 are detected.

When a dragging operation of the first touch input 1301 is input in a direction such that radii of the fan-shaped region formed by the first touch input point and the second and third touch input points are reduced, the controller 220 may allow a plurality of objects included in the control region 1310 to be spread and when the dragging operation of the first touch input 1301 is input in a direction such that the radii are increased, the controller may allow the plurality of objects included in the control region 1310 to be grouped and displayed.

When a communication channel between the first smart phone 1300 and a second smart phone 1350 is formed, and the first smart phone 1300 and the second smart phone 1350 are connected through the communication channel, the controller may allow the control region 1310 of the first smart phone 1300 to be extended to a control region 1320 in the second smart phone 1350 and allow the control region 1320 to be displayed in the smart phone 1350.

Here, the communication channel may be formed between the first smart phone 1300 and the second smart phone 1350 using, for example, Bluetooth, WIFI, or ZIG-BEE.

When the dragging operation of the first touch input 1301 is input to a direction such that the radii formed by the first touch input point and the second and third touch input points are reduced on a screen of the first smart phone 1300, the controller may spread the plurality of objects 1311, 1312, 1313, 1314, and 1315 included in the control region 1320 displayed on the screen of the second smart phone 1350 to be displayed.

When the dragging operation of the first touch input 1301 is input to a direction such that the radii formed by the first touch input point and the second and third touch input points are increased on the screen of the first smart phone 1300, the controller may group the plurality of objects 1311, 1312, 1313, 1314, and 1315 included in the control region 1320 displayed on the screen of the second smart phone 1350 to be displayed.

When the controller performs object grouping or object spreading on the second smart phone 1350, the controller may transmit and receive files using the communication channel formed between the first smart phone 1300 and the second smart phone 1350.

When it is determined that the first touch input 1301, the second touch input 1302, and the third touch input 1303 are maintained for a preset period of time in a state in which the control region 1310 is set based on the first touch input 1301, the second touch input 1302, and the third touch input 1303, the controller may display a menu window (not shown) on the screen of the first smart phone 1300.

Here, the menu window may be implemented with an OSD or a GUI, and the controller may display the menu window which displays a sub menu including an editing function such as copy, delete, paste, and the like.

When the sub menu displayed on the menu window is selected in a state in which the menu window is displayed, the controller may perform a function corresponding to the selected sub menu with respect to the plurality of objects 1311, 1312, 1313, 1314, and 1315 included in the control region 1320 of the second smart phone 1350.

The controller may group or spread the plurality of objects 1311, 1312, 133, 1314, and 1315 included in the control region 1320 of the second smart phone 1350 in a state in which the menu window is displayed on the screen of the first smart phone 1300, and perform a function corresponding to a sub menu for all or a portion of the plurality of objects grouped or spread.

Alternatively, the controller may display the menu window and perform a function corresponding to the sub menu with respect to all or a portion of the plurality of objects grouped or spread after the plurality of objects 1311, 1312, 1313, 1314, and 1315 included in the control region of the second smart phone 1350 are grouped or spread.

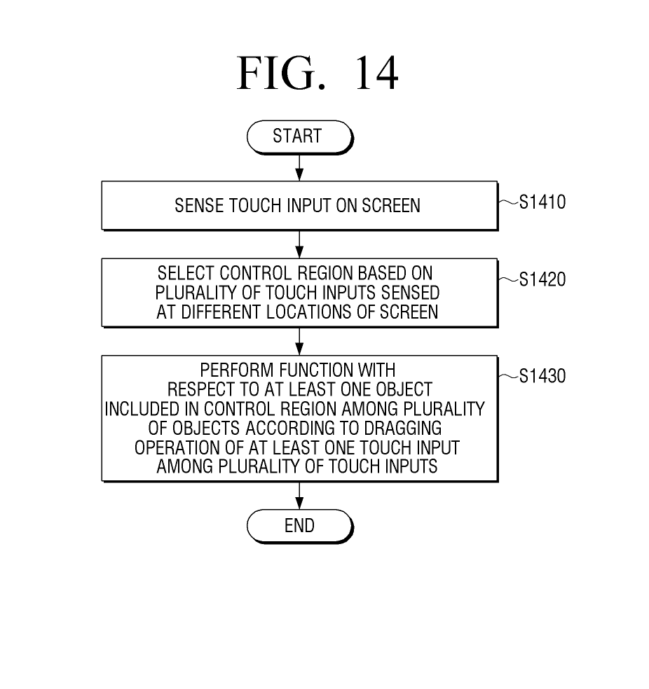

FIG. 14 is a flowchart illustrating a process of performing object grouping and object spreading for a detected touch input according to an exemplary embodiment.

A display apparatus may detect a touch input with respect to a screen (S1410). Here, the display apparatus may detect a plurality of touch inputs input through a touch panel or a touch screen.

The plurality of touch inputs may include a plurality of touch inputs input at different locations of the display with a time difference therebetween, a plurality of touch inputs input simultaneously at different locations of the display, or a plurality of touch inputs input at the same location.

The display apparatus may set a control region based on the plurality of touch inputs detected at different points of the screen (S1420). Here, the display apparatus may determine whether the plurality of touch inputs are detected at the different points of the screen or detected at the same location based on information of the plurality of touch inputs.

Specifically, the display apparatus may set a control region extended from a region formed by a plurality of touch input points in which the plurality of touch inputs are detected. Accordingly, the display apparatus may control at least one object included in the extended region among objects located farther away using the control region extended from the region formed by the plurality of touch input points.

The display apparatus may perform different functions on at least one object included in the control region among the plurality of objects according to a dragging operation of at least one touch input among the plurality of touch inputs (S1430).

Specifically, the display apparatus may recognize the dragging operation of the at least one touch input of the plurality of touch inputs and perform a function corresponding to a dragging input.

For example, when the display apparatus recognizes the dragging operation of the at least one touch input among the plurality of touch inputs with respect to the display, the display apparatus may adjust the control region set based on the plurality of touch inputs and perform functions such as edit, group, spread, or transfer on the at least one object included in the control region.

In particular, the display apparatus may perform an object grouping function or an object spreading function according to a dragging operation direction for the at least one touch input among the plurality of touch inputs.

For example, the display apparatus may perform the object grouping function when the dragging direction for the at least one touch input among the plurality of touch inputs is a direction moving away from a location in which the objects are located, and perform the object spreading function when the dragging direction is a direction moving toward a location in which the grouped objects are located.

The display apparatus may perform an editing function for the at least one object included in the control region when the touch inputs are maintained for a preset period of time.

A non-transitory computer-recordable medium, in which a program for performing a control method according to exemplary embodiments is stored, may be provided.

The non-transitory computer-recordable medium is not a medium configured to temporarily store data such as a register, a cache, or a memory but an apparatus-readable medium configured to semi-permanently store data. Specifically, the above-described applications or programs may be stored and provided in the non-transitory apparatus-readable medium such as a compact disc (CD), a digital versatile disc (DVD), a hard disc, a Blu-ray disc, a universal serial bus (USB), a memory card, a ROM, and the like.

Although a bus has not been shown in the block diagram illustrating the display apparatus, communication between the components in the display apparatus may be performed through the bus. Further, a CPU or a processor configured to perform the above-described operations, such as a microprocessor, may be further included in the device.

According to the above-described various embodiments, it is possible to control objects in a range beyond reach without performing repeated operations by using a plurality of touch inputs.

Although the above exemplary embodiments describe performing a function of grouping or spreading objects, it should be noted that any other functions with respect to objects included in a control region set based on a plurality of touch inputs may be performed.

Also, although the above exemplary embodiments describe performing a function (e.g., an object grouping function or an object spreading function) according to a dragging operation of at least one touch input among a plurality of touch inputs, it should be noted that the object grouping or object spreading function may be performed according to any other types of additional touch operation of at least one touch input among a plurality of touch inputs. Examples of the additional touch operation may include tap, drag, flick, and drag and drop operations.

Further, although the above exemplary embodiments describe performing a function according to an additional touch input operation (e.g., a dragging operation) of at least one touch input among a plurality of detected touch inputs, it should be noted that a function may be performed according to a touch operation at a place other than touch input points at which the plurality of touch inputs are detected.

Further, although the above exemplary embodiments describe setting a control region based on a plurality of touch inputs, the control region may be set based on a single continuous touch operation which defines a specific area on a screen.

The foregoing exemplary embodiments and advantages are merely exemplary and are not to be construed as limiting. The exemplary embodiments can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a display configured to display a plurality of objects;
a sensor configured to detect a touch input on the display; and
a controller configured to set a control region based on a plurality of touch inputs detected at different locations of the display and perform a function with respect to at least one object included in the control region according to an additional touch operation in the control region.

2. The display apparatus as claimed in claim 1, wherein the controller sets the control region extended from a region formed by a plurality of touch input points in which the plurality of touch inputs are detected.

3. The display apparatus as claimed in claim 1, wherein the controller performs at least one of an object grouping function and an object spreading function according to the additional touch operation.

4. The display apparatus as claimed in claim 1, wherein the plurality of touch inputs includes a first touch input through a third touch input, and
wherein the controller sets the control region extended from a fan-shaped region, having a vertex which is a first touch input point in which the first touch input is detected and radii are lines formed by the first touch input point and second and third touch input points in which a second and the third touch inputs are detected.

5. The display apparatus as claimed in claim 4, wherein the first touch input is input in a state in which the second and the third touch inputs are maintained for a preset period of time after the second and the third touch inputs are detected.

6. The display apparatus as claimed in claim 4, wherein the additional touch operation is a dragging operation, and
the controller controls to spread the at least one object included in the control region when a dragging operation of the first touch input is input in a direction such that radii of the fan-shaped region formed by the first touch input point and the second and the third touch input points are reduced, and controls to group the at least one object included in the control region when the dragging operation of the first touch input is input in a direction such that the radii of the fan-shaped region are increased.

7. The display apparatus as claimed in claim 4, wherein the controller adjusts a size of the control region according to an additional touch operation of at least one of the second and the third touch inputs.

8. The display apparatus as claimed in claim 4, wherein the controller performs an editing function for the at least one object included in the control region when the plurality of touch inputs are maintained for a preset period of time.

9. The display apparatus as claimed in claim 1, wherein the plurality of touch inputs detected at different locations of the display are detected in a continuous touch operation.

10. The display apparatus as claimed in claim 1, wherein the additional touch operation in the control region is input at least one of the different locations at which the plurality of touch inputs are detected.

11. A method of controlling a display apparatus, the method comprising:
detecting touch inputs on a screen;
setting a control region based on a plurality of touch inputs detected at different points of the screen; and
performing a function for at least one object included in the control region according to an additional touch operation in the control region.

12. The method as claimed in claim 11, wherein the setting comprises setting the control region extended from a region formed by a plurality of touch input points in which the plurality of touch inputs are detected.

13. The method as claimed in claim 11, wherein the performing comprises performing at least one of an object grouping function and an object spreading operation according to the additional touch operation.

14. The method as claimed in claim 11, wherein the plurality of touch inputs includes a first touch input through a third touch input, and
wherein the setting comprises setting the control region extended from a fan-shaped region, having a vertex which is a first touch input point in which the first touch input is detected and radii are lines formed by second and third touch input points in which a second and the third touch inputs are detected.

15. The method as claimed in claim 14, wherein the first touch input is input in a state in which the second and the third touch inputs are maintained for a preset period of time after the second and the third touch inputs are sensed.

16. The method as claimed in claim 14, wherein the additional touch operation is a dragging operation, and
the performing comprises spreading the at least one object included in the control region when a dragging operation of the first touch input is input in a direction such that radii of the fan-shaped region formed by the first touch input point and the second and the third touch input points are reduced and grouping the at least one object included in the control region when the dragging operation of the first touch input is input in a direction such that the radii of the fan-shaped region are increased.

17. The method as claimed in claim 14, further comprising adjusting a size of the control region according to an additional touch operation of at least one of the second and the third touch inputs.

18. The method as claimed in claim 14, further comprising performing an editing function for the at least one object included in the control region when the plurality of touch inputs are maintained for a preset period of time.

19. The method as claimed in claim 11, wherein the additional touch operation in the control region is input at least one of the different points at which the plurality of touch inputs are detected.

20. A display apparatus comprising:
a processor configured to set a control region based on a plurality of touch inputs detected at different locations of a display and control at least one object included in the control region according to an additional touch operation in the control region.
